(19) United States
(12) Patent Application Publication
(10) Pub. No.: US 2017/0238247 A1
(43) Pub. Date: Aug. 17, 2017

(54) METHOD AND APPARATUS FOR TRACKING IDLE DEVICES

(71) Applicant: Nokia Solutions and Networks Oy, Espoo (FI)

(72) Inventors: Subramanya CHANDRASHEKAR, Bangalore (IN); Hans Thomas HOEHNE, Helsinki (FI); Irina-Mihaela BALAN, Munich (DE); Richard WALDHAUSER, Munich (DE); Güenther HORN, München (DE); Dario Serafino TONESI, Sabbio Chiese BS (IT)

(21) Appl. No.: 15/514,697

(22) PCT Filed: Sep. 30, 2014
(86) PCT No.: PCT/EP2014/070924

§ 371 Date: Mar. 27, 2017

(51) Int. Cl. H04W 48/20; H04W 24/08; H04W 24/10; H04W 76/04; H04W 48/18

(52) U.S. Cl. CPC H04W 48/20; H04W 76/048; H04W 48/18; H04W 24/10; H04W 24/08; H04W 84/12

(57) ABSTRACT

A method and apparatus can be configured to notify that the apparatus has changed a network node upon which the apparatus is camped on. The apparatus changes from camping on a first network node to camping on a second network node. The apparatus is in idle mode while camping on the first and the second network node. The first network node and the second network node both belong to a first network. The notifying is performed when the apparatus maintains a session to a third network node of a second network. The notifying is not performed when the apparatus is not maintaining a session to the third network node of the second network.

### BACKGROUND

Field

Embodiments of the invention relate to tracking idle devices.

Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method may comprise notifying, by a user equipment, that the user equipment has changed a network node upon which the user equipment is camped on. The user equipment may change from camping on a first network node to camping on a second network node. The user equipment may be in idle mode while camping on the first and the second network node. The first network node and the second network node may both belong to a first network. The notifying may be performed when the user equipment maintains a session to a third network node of a second network. The notifying may be not performed when the user equipment is not maintaining a session to the third network node of the second network.

In the method of the first embodiment, the first and the second network node may belong to at least one of the same tracking area and the same routing area.

In the method of the first embodiment, the session may comprise an active connection to a Wireless Local Area Network access point.

In the method of the first embodiment, the notifying may comprise transmitting a first information to the second network node. The first information may comprise at least one of an identifier of the third network node and a discontinuous-reception information.

In the method of the first embodiment, the notifying may comprise transmitting a Status Update message.

In the method of the first embodiment, the notifying may further comprise transmitting a second information to the second network node. The transmitting the second information may comprise transmitting an identifier for the user equipment. The identifier for the user equipment may comprise at least one of an International Mobile Subscriber Identity, a Globally-Unique-Temporary-Identity, a Temporary-Mobile-Subscriber Identity and a self-generated random number acting as a temporary identity for the user equipment.

In the method of the first embodiment, the notifying may comprise transmitting a second network traffic characteristic corresponding to at least one of a second network offloaded traffic volume over a past period, an application traffic type, and an access class.

In the method of the first embodiment, the notifying may be performed if a broadcast is received which contains an indication that allows the user equipment to do so.

In the method of the first embodiment, the first network may comprise a Third Generation Partnership Project Long-Term Evolution network.

In the method of the first embodiment, the second network may comprise a Wireless Local Area Network.

In the method of the first embodiment, the first network node and the second network node may correspond to a base station.

According to a second embodiment, an apparatus may comprise a notifying means to notify that the apparatus has changed a network node upon which the apparatus is camped on. The apparatus may change from camping on a first network node to camping on a second network node. The apparatus may be in idle mode while camping on the first and the second network node. The first network node and the second network node both may belong to a first network. The notifying may be performed when the apparatus maintains a session to a third network node of a second network. The notifying may be not performed when the apparatus is not maintaining a session to the third network node of the second network.

In the apparatus of the second embodiment, the first and the second network node may belong to at least one of the same tracking area and the same routing area.

In the apparatus of the second embodiment, the session may comprise an active connection to a Wireless Local Area Network access point.

In the apparatus of the second embodiment, the notifying may comprise transmitting a first information to the second network node. The first information may comprise at least one of an identifier of the third network node and a discontinuous-reception information.

In the apparatus of the second embodiment, the notifying may comprise transmitting a Status Update message.

In the apparatus of the second embodiment, the notifying may comprise transmitting a second information to the second network node. The transmitting the second information may comprise transmitting an identifier for the apparatus. The identifier for the apparatus may comprise at least one of an International Mobile Subscriber Identity, a Globally-Unique-Temporary-Identity, a Temporary-Mobile-Subscriber Identity, and a self-generated random number acting as a temporary identity for the apparatus.

In the apparatus of the second embodiment, the notifying may further comprise transmitting a second network traffic characteristic corresponding to at least one of a second network offloaded traffic volume over a past period, an application traffic type, and an access class.

In the apparatus of the second embodiment, the notifying may be performed if a broadcast is received which contains an indication that allows the apparatus to do so.

In the apparatus of the second embodiment, the first network may comprise a Third Generation Partnership Project Long-Term Evolution network.

In the apparatus of the second embodiment, the second network may comprise a Wireless Local Area Network.

In the apparatus of the second embodiment, the first network node and the second network node may correspond to a base station.

According to a third embodiment, a computer program product may be embodied on a non-transitory computer readable medium. The computer program product may be configured to control a processor to perform the method of the first embodiment.

According to a fourth embodiment, a method may comprise receiving, by a first network node, a notification that a user equipment has changed a network node upon which the user equipment is camped on. The user equipment may change from camping on a second network node to camping on the first network node. The user equipment may be in idle mode while camping on the first and the second network node. The second network node and the first network node may both belong to a first network. The method may also comprise forwarding information of the notification to a third network node of a second network.

In the method of the fourth embodiment, the notification may not be related to a tracking area update notification or a routing area update notification.

In the method of the fourth embodiment, the method may also comprise fetching user-equipment context information from the second network node.

In the method of the fourth embodiment, the notification may comprise a first information. The first information may comprise at least one of an identifier of the third network node and a discontinuous-reception information.

In the method of the fourth embodiment, the notification may comprise a Status Update message.

In the method of the fourth embodiment, the notification may comprise an identifier for the user equipment. The identifier for the user equipment may comprise at least one of an International Mobile Subscriber Identity, a Globally-Unique-Temporary-Identity, a Temporary-Mobile-Subscriber Identity and a self-generated random number acting as a temporary identity for the user equipment.

In the method of the fourth embodiment, the notification may comprise a second network traffic characteristic corresponding to at least one of a second network offloaded traffic volume over a past period, an application traffic type, and an access class.

In the method of the fourth embodiment, the method may further comprise transmitting an indication to a node of the first network enabling the sending of the notification by the node of the first network.

In the method of the fourth embodiment, the forwarding information of the notification to the third network node may comprise forwarding information to a Wireless Local Area Network access point.

In the method of the fourth embodiment, the forwarding information of the notification to the third network node may comprise forwarding at least one of an identifier of the first network node and a discontinuous-reception information.

In the method of the fourth embodiment, the first network may comprise a Third Generation Partnership Project Long-Term Evolution network.

In the method of the first embodiment, the second network may comprise a Wireless Local Access Network.

In the method of the first embodiment, the first network node and the second network node may correspond to a base station.

According to a fifth embodiment, an apparatus may comprise receiving means to receive a notification that a user equipment has changed a network node upon which the user equipment is camped on. The user equipment may change from camping on a first network node to camping on the apparatus. The user equipment may be in idle mode while camping on the apparatus and the first network node. The first network node and the apparatus both may belong to a first network. The apparatus may also comprise forwarding means to forward information of the notification to a second network node of a second network.

In the apparatus of the fifth embodiment, the notification may not be related to a tracking area update notification or a routing area update notification.

In the apparatus of the fifth embodiment, the apparatus may also comprise fetching means to fetch user-equipment context information from the first network node.

In the apparatus of the fifth embodiment, the notification may comprise a first information. The first information may comprise at least one of an identifier of the second network node and a discontinuous-reception information.

In the apparatus of the fifth embodiment, the notification may comprise a Status Update message.

In the apparatus of the fifth embodiment, the notification may comprise an identifier for the user equipment. The identifier for the user equipment may comprise at least one of an International Mobile Subscriber Identity, a Globally-Unique-Temporary-Identity, a Temporary-Mobile-Subscriber Identity and a self-generated random number acting as a temporary identity for the user equipment.

In the apparatus of the fifth embodiment, the notification may comprise a second network traffic characteristic corresponding to at least one of a second network offloaded traffic volume over a past period, an application traffic type, and an access class.

In the apparatus of the fifth embodiment, the apparatus may further comprise transmitting means to transmit an indication to a node of the first network enabling the sending of the notification by the node of the first network.

In the apparatus of the fifth embodiment, the forwarding information of the notification to the second network node may comprise forwarding information to a Wireless Local Area Network access point.

In the apparatus of the fifth embodiment, the forwarding information of the notification to the second network node may comprise forwarding at least one of an identifier of the apparatus and a discontinuous-reception information.

In the apparatus of the fifth embodiment, the first network may comprise a Third Generation Partnership Project Long-Term Evolution network.

In the apparatus of the fifth embodiment, the second network may comprise a Wireless Local Area Network.

In the apparatus of the fifth embodiment, the apparatus and the first network node may correspond to a base station.

According to a sixth embodiment, a computer program product may be embodied on a non-transitory computer readable medium. The computer program product may be configured to control a processor to perform the method of the fourth embodiment.

According to a seventh embodiment, a system may comprise a first apparatus. The first apparatus may comprise notifying means to notify that the first apparatus has changed a network node upon which the first apparatus is camped on. The first apparatus may change from camping on a first network node to camping on a second apparatus, the first apparatus may be in idle mode while camping on the first network node and the second apparatus, and the second apparatus and the first network node may both belong to a first network. The notifying may be performed when the first apparatus maintains a session to a second network node of a second network. The notifying may be not performed when the first apparatus is not maintaining a session to the second network node of the second network. The system may comprise a second apparatus. The second apparatus may comprise receiving means to receive the notification that the first apparatus has changed a network node upon which the first apparatus may be camped on. The second apparatus may comprise forwarding means to forward information of the notification to the second network node of the second network.

According to a eighth embodiment, an apparatus may comprise at least one processor and at least one memory including computer program code. The at least one memory and the computer program code may be configured, with the at least one processor, to cause the apparatus at least to notify that the apparatus has changed a network node upon which the apparatus is camped on, wherein the apparatus may change from camping on a first network node to camping on a second network node, the apparatus may be in idle mode while camping on the first and the second network node, and the first network node and the second network node may both belong to a first network. The notifying may be performed when the apparatus maintains a session to a third network node of a second network. The notifying may be not performed when the apparatus is not maintaining a session to the third network of the second network.

According to an ninth embodiment, an apparatus may comprise at least one processor and at least one memory including computer program code. The at least one memory and the computer program code may be configured, with the at least one processor, to cause the apparatus at least to receive a notification that a user equipment has changed a network node upon which the user equipment is camped on. The user equipment may change from camping on a first network node to camping on the apparatus, the user equipment may be in idle mode while camping on the apparatus and the first network node. The first network node and the apparatus may both belong to a first network. The apparatus may also be caused to forward information of the notification to a second network node of a second network.

### BRIEF DESCRIPTION OF THE DRAWINGS

For proper understanding of the invention, reference should be made to the accompanying drawings, wherein:

FIG. 1(a) illustrates one example embodiment of performing idle-UE-enB update.

FIG. 1(b) illustrates another example embodiment of performing idle-UE-eNB update.

FIG. 2 illustrates one example of sending a status update that contains a known user equipment (UE) identifier.

FIG. 3 illustrates a UE informing an eNB that the UE has WLAN connectivity, in accordance with one embodiment of the present invention.

FIG. 4 illustrates performing offloading in accordance with one embodiment.

FIG. 5 illustrates changing an evolved Node B (eNB) in idle mode in accordance with one embodiment.

FIG. 6 illustrates an Access-Point change in idle mode in accordance with one embodiment.

FIG. 7 illustrates a flowchart of a method in accordance with embodiments of the invention.

FIG. 8 illustrates an apparatus in accordance with embodiments of the invention.

FIG. 9 illustrates an apparatus in accordance with embodiments of the invention.

FIG. 10 illustrates a method in accordance with embodiments of the invention.

FIG. 11 illustrates an apparatus in accordance with embodiments of the invention.

FIG. 12 illustrates an apparatus in accordance with embodiments of the invention.

FIG. 13 illustrates an apparatus in accordance with embodiments of the invention.

FIG. 14 illustrates a system in accordance with embodiments of the invention.

### DETAILED DESCRIPTION

Certain embodiments of the present invention relate to tracking idle devices. Certain embodiments of the present invention may relate to tracking devices that are in connected mode. Embodiments of the present invention may relate to interworking between two networks comprising different technologies, specifically between 3GPP and Wireless-Local-Area-Network (WLAN) technologies. 3GPP has standardized mobile wireless access technologies such as LTE, while WLAN mobile wireless access technologies are based on IEEE standard 802.11. Currently, many user equipment (UEs) are equipped with both 3GPP capability and WLAN capability. In other words, many UEs are equipped with at least one 3GPP Radio-Access Technology as well as a WLAN radio interface. Recently, operators have started deploying WLAN Access Points, and operators are seeking to achieve better coordination between the WLAN and the 3GPP networks.

Embodiments of the present invention may perform updating of addressing information or routing information of network nodes (such as WLAN and 3GPP RAN nodes, for example) during mobility, while the UE is in idle mode, is registered to 3GPP, and has a WLAN connection. As described in further detail below, a UE device may be attached to, connected to, and/or camping on a network. “Attaching” generally means that the device has registered itself to an EPC (Packet Core network). The EPC is generally able to reach the attached device via paging if there is no active connection with the EPC. Whether a connection exists (i.e., an “active” mode) or a connection does not exist (i.e., an “idle” mode) is irrelevant for the attached state. “Connecting” generally means that the device has a RAN connection and some dedicated channel. Both may be able to immediately send to each other. “Connected” generally corresponds to an “active” mode. “Camping” generally means that the device does not have a connection with a RAN (the device is in “idle” mode) and is just listening to broadcasts from the cell under which the device is camping on.

Embodiments of the present invention may relate to automatically determining which WLAN Access Points (WLAN APs) are within a coverage area of a specific 3GPP RAN node, while the UE is in idle mode, while registered to 3GPP RAN, and undergoing mobility. This process is also called Automatic Neighbor Relations (ANR). One example of a 3GPP RAN node may be an eNB with respect to LTE. UEs that offloaded all traffic to WLAN, or UEs that started a new session directly in WLAN without any 3GPP session, are considered to be in idle mode in 3GPP. A UE may be moved to idle if there is no bearer/session in 3GPP.

A UE maintaining or starting a session with a WLAN AP may be interpreted as a UE associated with the WLAN AP, where there may be traffic flowing between the UE and the WLAN AP utilizing this session. The session may be an offloading session and the traffic may be offloaded traffic transmitted from the UE to the WLAN AP.

Moving traffic from a 3GPP network to WLAN is a process that is referred to as “offloading.” Conversely, “onloading” refers to the process of moving a UE's traffic from WLAN to 3GPP. When a UE performs offloading, the 3GPP network may not be aware of the offloading process. Regardless of whether the UE is in 3GPP-idle mode or in 3GPP-connected mode, the current 3GPP network may not be able to know whether the UE is offloading some or all of its traffic to WLAN.

Certain problems may exist with the previous approaches. For example, with the previous approaches, when a UE is registered to a 3GPP RAN in idle mode, a change of eNB connectivity (from one eNB to another eNB) by the UE may not be reported to the network by the UE under all scenarios. In particular, the changing of the eNB by the UE may not be reported to the network if the new eNB is in a same tracking area as the old eNB. Even in case the tracking area has changed, this change is not reported to the network if the Tracking Area Index (TAI) (tracking area index) at the new eNB is contained in the TAI list that is assigned by the MME to the UE. The TAI list may identify the tracking areas a UE can enter without performing a tracking area updating procedure. As such, the WLAN Access Points (APs) will generally not have updated information regarding the utilized connected eNB. Further, the new eNB will generally not have WLAN AP information (neither old AP information nor new AP information) when the UE changes APs. Because the new eNB does not have AP information, performing onloading of traffic to 3GPP for certain UEs may be impossible. Currently, no feedback is provided to a serving 3GPP RAN node about a total traffic that is offloaded to WLAN. The 3GPP RAN may have no visibility of these UEs. The same holds true for UEs that perform cell reselection while idle and which have traffic in WLAN.

Further, with the previous approaches, because no feedback is provided to a serving RAN Node regarding a total amount of traffic offload to WLAN, the serving RAN node has no visibility of idle-mode UEs. The serving RAN node may also have no visibility of UEs that perform cell reselection while idle in 3GPP and that have traffic in WLAN. As described in further detail below, UEs that have all their traffic offloaded to WLAN or that have started a new session directly in WLAN may be considered to be idle in 3GPP.

According to RAN assisted WLAN Interworking, the RAN node may trigger onload of idle UEs, for example, by information transmitted by System Information Block 17. Because this information may be read by all idle UEs, the settings of the thresholds and the number of idle UEs may determine a future load of the RAN node, however, the RAN node has no clue about this future load since it may not be aware about UEs in idle mode camping on cell(s) of the RAN node, and about the amount of traffic which may be onloaded from those UEs.

Therefore, it may be desirable for the idle UEs to provide an indication of their presence to the serving RAN node. Otherwise, the idle UEs are generally invisible to their camping cell. Such an indication may also comprise information related to offloaded traffic.

To further describe the previous approaches, in a network-based ANR, the UEs are generally assumed to have a serving connection to an eNB. Otherwise, if the UEs do not have a serving connection to an eNB, no neighbour relations may be established.

In the previous approaches, a Core Network node, like a Mobility-Management-Entity (MME), a Packet Data Network (PDN) Gateway (P-GW), or an eNB, may carry out ANR mapping in conjunction with the WLAN authentication server. Also, the previous approaches may not achieve the functionality of embodiments of the present invention, even though MME may be aware of idle UEs. The previous approaches do not achieve the functionality of embodiments of the present invention because, during a UE's idle state mobility, the MME is only informed about the UE's idle state mobility when the UE issues a Tracking Area Update (TAU). However, the UE will not issue a TAU if it moves between eNBs belonging, for example, to the same tracking area.

Further, the previous approaches are directed to establishing a map. However, with the previous approaches, continuous tracking and reporting of UEs is not possible. As such, according to the previous approaches, the mapping is only performed at certain times. However, for reaching idle UEs, the presence of the idle UEs (within an eNB's coverage) may need to be known at all times because UEs of the same APs may be connected/camped with different eNBs. Hence, an exact UE-eNB mapping may be necessary.

In another previous approach, an identifier containing the RAN node Id is generated by some element in RAN or Non-Access Stratum (NAS) and communicated to the UE. However, generating the identifier only partially addresses the problem of indicating the presence of UEs during setup of a WLAN connection. With this previous approach, it may not be possible to handle subsequent mobility in idle mode.

TAU may inform an MME about when a UE has travelled to a new tracking area. With embodiments of the present invention, the UE signalling may be terminated at the eNB, and updates may be sent only when the UE also has WLAN connectivity.

In certain embodiments of the present invention, there may be a direct interface between the WLAN and the 3GPP RAN. The direct interface may allow, for example, an eNB to retrieve information. The retrieved information may comprise throughput and other traffic parameters. In certain embodiments of the present invention, the UE may be in Radio-Resource-Control-idle (RRC-idle) mode. 3GPP Release 12 Interworking may be supported by both the network and the UE.

Embodiments of the present invention may maintain eNB-addressing information at WLAN AP and WLAN AP/AC addressing information at eNB during idle-mode mobility. Embodiments of the present invention may be based on the principle of establishing Automatic-Neighbor-Relations (ANR) when the UE is registered to 3GPP in idle mode. Embodiments of the present invention may use a RAN-WLAN direct interface.

Embodiments of the present invention may be used to maintain ANR during mobility when the UE is registered to 3GPP in connected mode also. Embodiments of the present invention may use a RAN-WLAN direct interface to establish eNB-addressing information at WLAN AP/AC and WLAN AP/AC addressing information at eNB during mobility.

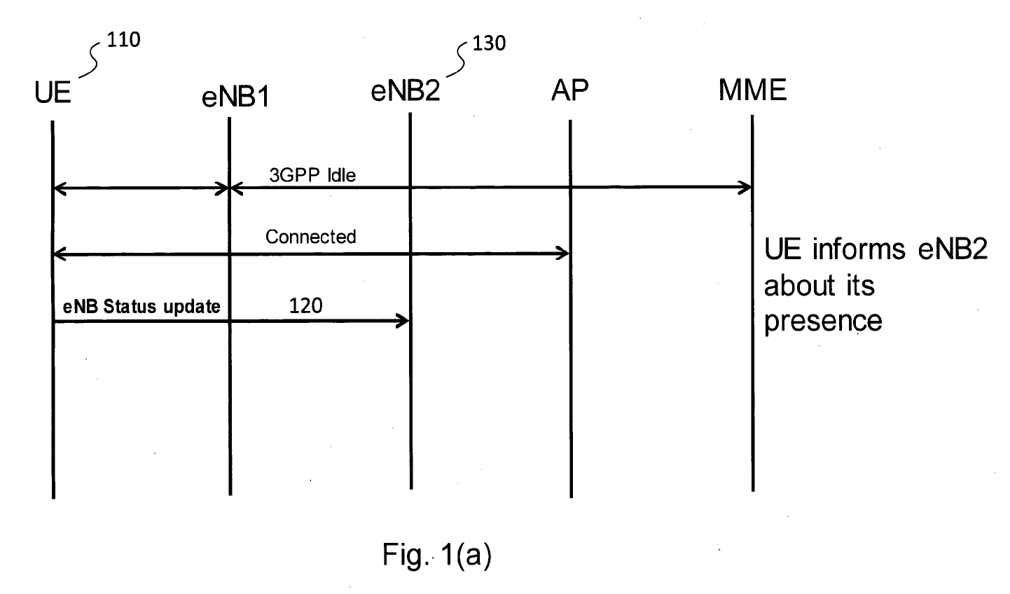

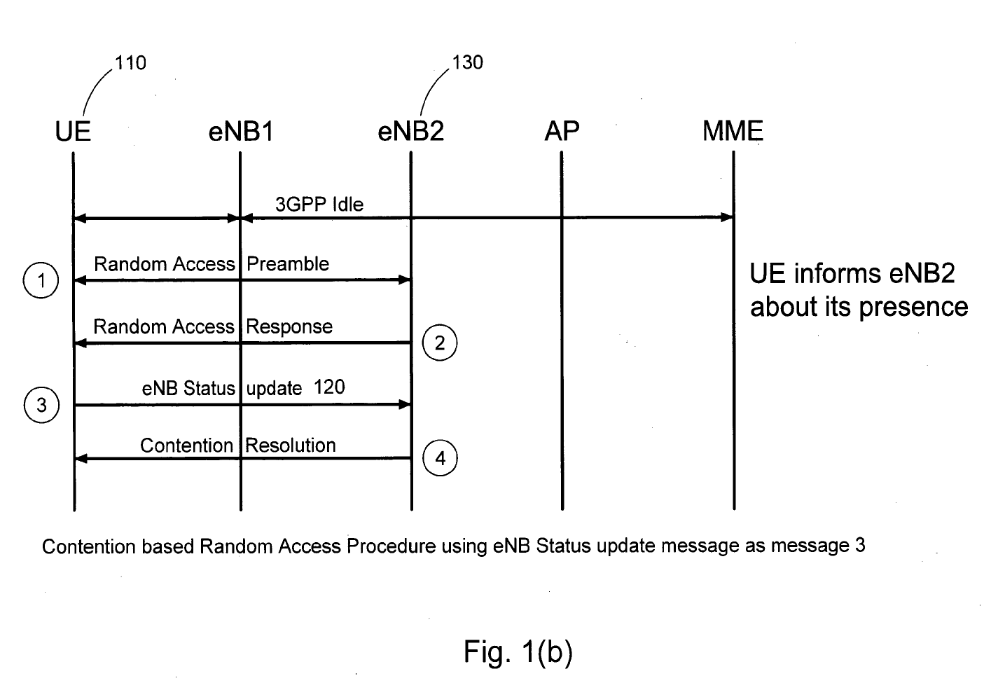

FIG. 1(a) illustrates one example embodiment of performing idle-UE-eNB update. As shown by FIG. 1(a), the UE 110 may send an eNB status update 120. In certain embodiments, the status update may contain no information. In the event that the status update contains no information, the UE 110 may be implicitly known to have WLAN traffic. The eNB 130 may not know the ID of the UE 110.

FIG. 1(b) illustrates another example embodiment of performing idle-UE-eNB update. In this embodiment, the UE does not provide a UE identifier that is unique within the whole Public-Land-Mobile-Network (PLMN) or a subpart thereof (for example, an IMSI, a GUTI, or a TMSI). The eNB may assign a Cell-Radio Network Temporary Identifier (C-RNTI) in message 2 of FIG. 1(b) of E-UTRAN's random access procedure. The UE 110 uses this C-RNTI for identification in announcing itself via the new eNB Status update message, as shown by message 3 of the random access procedure of FIG. 1(b). The C-RNTI may become a permanent identification for UE 110 while camping at eNB's 130 cell upon the contention resolution message 4 of the random access procedure. The C-RNTI may be unique within the cell only. The advantage of this is that it is a simple solution to announce the presence of the UE 110 to eNB 130. Another advantage is, that the C-RNTI can be easily transferred over unsecured communication over the air interface. It may not be possible to track the movement of UE 110 during idle mode mobility because the C-RNTI is newly assigned by the eNB at every new announcement. The C-RNTI may be stored by the eNB 130 and may be used later on by the eNB 130 when needed. For example, when eNB 130 wants to send a paging message to UE 110 it can use this C-RNTI as a paging identity within the paging record. To avoid the need for performing eNB Status updates at every cell change while the UE 110 is camping on any cells belonging to the same eNB, the eNB 130 may also provide the corresponding cell specific C-RNTIs that are valid while camping in these other cells of eNB in a contention resolution message 4 of the random access procedure. Then, UE 110 knows then which C-RNTI is valid while camping on a specific cell of the eNB 110.

Instead of using a cell specific C-RNTI, in another example embodiment, the eNB 130 may assign an identity which is a unique identification for the UE 110 while it is camping in any of the cells that are under control of eNB 130, e.g., a new node RNTI (N-RNTI).

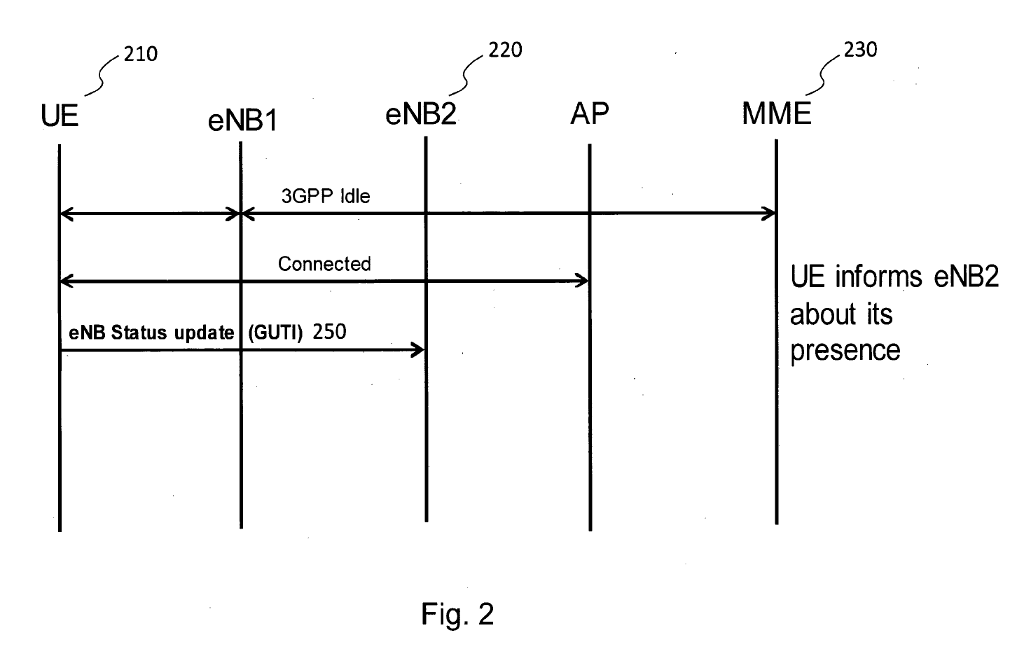

FIG. 2 illustrates one example of sending a status update that contains a known UE identifier. In certain embodiments of the present invention, the status update message 250 may contain a UE identifier that is unique within the whole Public-Land-Mobile-Network (PLMN) or a subpart thereof (for example, an IMSI, a GUTI, or a TMSI). The SAE-Temporary-Mobile-Subscriber-Identity (S-TMSI) may be used for paging in LTE. FIG. 2 illustrates transmitting a status update 250 that contains a known UE identifier that identifies UE 210. In this embodiment, it may be implicit that the UE 210 has WLAN traffic. The eNB 220 may need to obtain UE-paging parameters, for example, from MME 230.

Instead of using the identities of the embodiment illustrated by FIG. 2, the UE may use a self-generated random number as a temporary ID as well. The UE may use a different temporary ID at every eNB. Using the different temporary ID at every eNB may have the benefit of providing higher security with regard to tracing the movement of the UE over several eNBs. Tracing the movement of the UE over several eNB may be achieved by listening to the UE's unsecured messaging to the eNBs.

In certain embodiments of the present invention, if the UE is configured for Discontinuous Reception (DRX), the UE may also transmit its DRX configuration to a RAN Node. Based on this DRX information, the RAN Node may then identify the UE for possible paging so that onloading may be performed. By including paging information within the announcement message transmitted from the UE to the RAN Node/eNB, embodiments of the present invention may provide the benefit of enabling paging to be initiated by the eNB, without the need to query that information from a core network. The UE may also relay further information to the eNB, such as information that indicates an amount of WLAN traffic that the UE has offloaded over a past period. The further information may also comprise other context information that is available at the UE. The other context information may be used to improve the eNB's decision regarding whether or not to return (onload) the WLAN traffic to 3GPP.

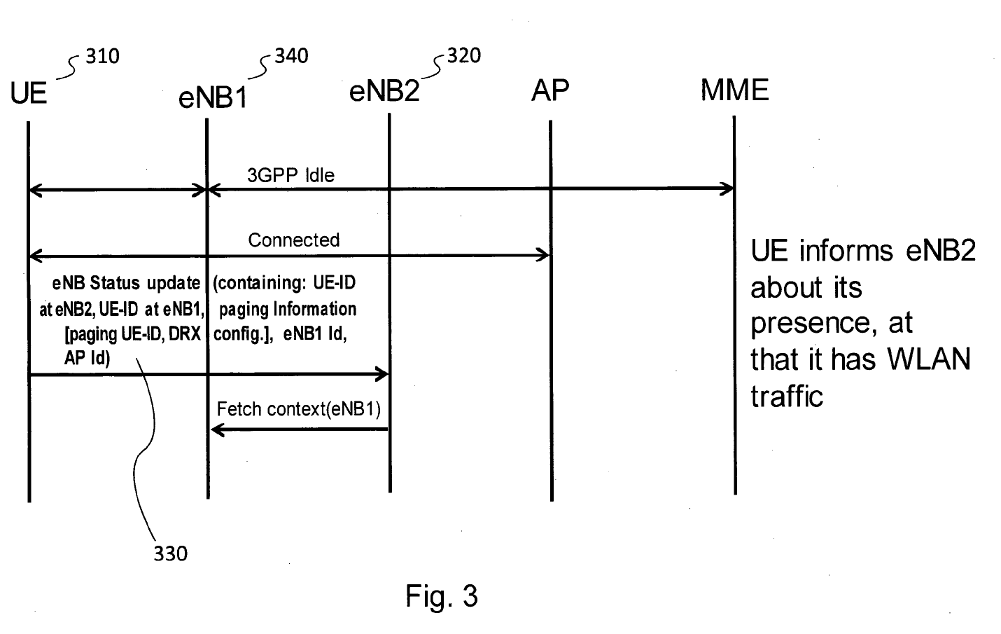

FIG. 3 illustrates a UE informing an eNB that the UE has WLAN connectivity in accordance with one embodiment of the present invention. In one embodiment, a UE 310 may transmit a message 330 to an eNB 320. The message 330 may comprise identities about the RAN node on which the UE 310 was previously camping, for example, the eNB IDs. If the UE ID that was used for the announcement at the previous eNB 340 is different from the UE ID that is used for the current announcement, then this previous UE ID may also be provided with the current announcement. Providing this information may be beneficial because the providing of this information may enable the RAN node 320 (at which the UE is newly announcing for camping) to fetch context from the previous RAN node 340.

In certain embodiments of the present invention, information (that does not need to be critically secured) may be sent to the UE, and this information may be stored at the UE during idle mode. The UE may provide this context information to an eNB via the eNB Status update message. Embodiments of the present invention may provide the advantage of providing a method where there is no need to fetch the context from another node.

In certain embodiments of the present invention, the message (transmitted by the UE to the eNB) may also contain the AP ID(s) of access points for which the UE has detected their relative signal strengths. The message may also comprise information about the WLAN traffic that the UE is having. It may be beneficial for the eNB to know what further suitable APs are around.

In certain embodiments, the UE may notify the eNB if the UE determines that the current WLAN service is not satisfactory. The UE may determine this based on quality of experience (QoE) configured parameters relating to WLAN traffic characteristics in dependence of the application generating or consuming the traffic.

In certain embodiments of the present invention, the eNB may add an element to its broadcast signal which can be used for controlling the UE notifications to the eNB. The added element may be signal toggle_notify. It may be helpful to know that, when an idle UE camps on a cell of a new eNB, it will acquire the eNB broadcast information. The broadcast information contains a number of system parameters, the so called system information. That is, in certain embodiments, a new system information element toggle_notify would be added to the eNB broadcast. This broadcasting may be useful when the eNB is overloaded. In the absence of the signal toggle_notify, or when toggle_notify takes certain values, the UE will not notify the eNB about its presence in the cell, and thus will not further load the air interface with signalling. This is beneficial in the case of high load at the eNB, where the eNB can cause UEs not to notify because the eNB could anyhow not onload more WLAN traffic. The signal toggle_notify may also control the amount of information that the UE is providing to the eNB in its notification.

In certain embodiments, the above-described procedures may operate without any WLAN-RAN interface.

If the UE stops its traffic in WLAN, the UE may discontinue the UE's association with the AP. The UE may then only be in 3GPP idle mode, and the UE may no longer be a candidate for onload in the RAN cell. Without a direct WLAN-RAN interface, the UE may have to inform the RAN node about a change in status. Alternatively, a timer may be started at the eNB and at the UE. When the timer expires while the UE still has ongoing WLAN traffic, the UE may inform the eNB of the UE's presence again. If the timer expires, and the UE has no more ongoing WLAN traffic, the eNB may clear the UE from a list of possible onload candidates.

In certain embodiments of the present invention, when eNBs maintain a context of visiting WLAN UEs, then an eNB may inform the previous eNB that the WLAN UE has migrated. The eNB may have been notified by a WLAN UE. The UE may inform the current eNB about the identity of the previous eNB. The current eNB may inform all neighbouring eNBs.

In certain embodiments, if a direct WLAN-RAN interface exists, the AP may inform the RAN node that the previously-identified UE does not have any more traffic. This will enable the RAN to consider the UE as a normal-idle-mode UE.

When the UMTS-Terrestrial-Radio-Access-Network (UTRAN) is informed about the UE's WLAN connectivity, the UE's Packet-Data-Convergence-Protocol (PDCP) context in the Serving-GPRS-Support-Node (SGSN) may be retained for a longer time to avoid fresh setups due to the UE coming back to the 3G network. The UE may come back to the 3G network due to multiple reasons. The UTRAN could get some free capacity and invoke onload of UEs back to 3G. Further, a changing radio quality of the UE at WLAN may force the UE back to 3G.

Embodiments of the present invention may enable the RAN to determine the potential onload candidates when RAN capacity is freed. With embodiments of the present invention, the UE may be known at the eNB level even in idle mode (and even when the UE is only connected to a WLAN network). This knowledge may enable a smooth paging procedure.

The above-described eNB update signalling may be used also for establishing ANR. The advantage provided by the eNB update signalling, as compared to network-based ANR, is that the eNB update signalling may operate faster.

When embodiments of the present invention are used for ANR, broadcast signalling that controls the UE updates may regulate whether UEs only update for the purpose of ANR (send only a full list of available APs), or whether the UEs update for the purpose of onloading.

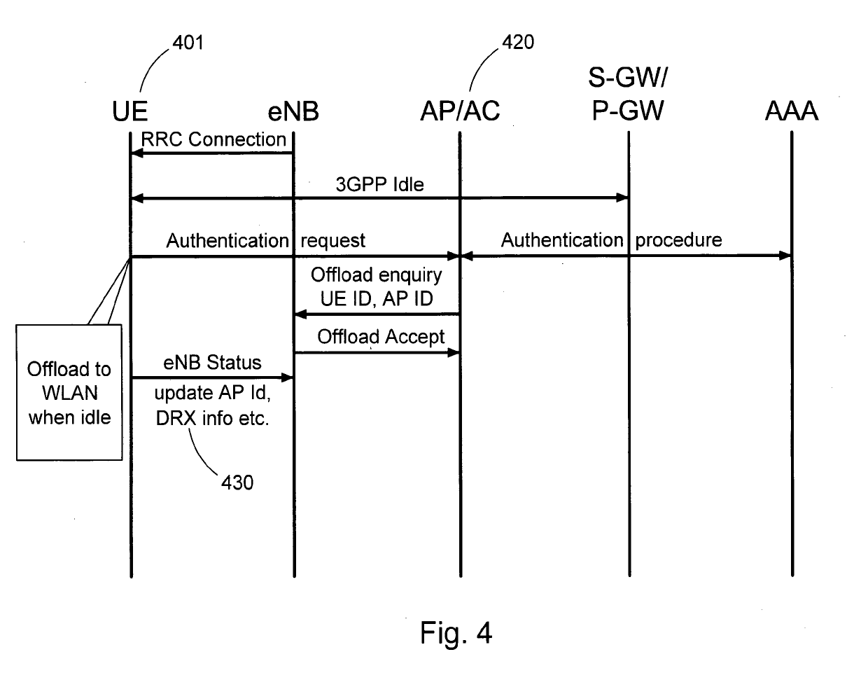

FIG. 4 illustrates performing offloading in accordance with one embodiment. Referring to FIG. 4, if a UE 401 begins establishing a connection and exchanges user data with WLAN AP 420, where the UE is registered in idle mode with 3GPP, the UE may provide addressing information (corresponding to the WLAN) to the eNB via an eNB Status Update message 430. The addressing information corresponding to the WLAN may comprise an Access Point ID and/or an Access Point Name of the WLAN AP, for example. The addressing information provided to the eNB via eNB Status Update message 430 may be obtained by WLAN in the UE's access request. The process illustrated by FIG. 4 may establish an initial ANR relation between RAN and WLAN.

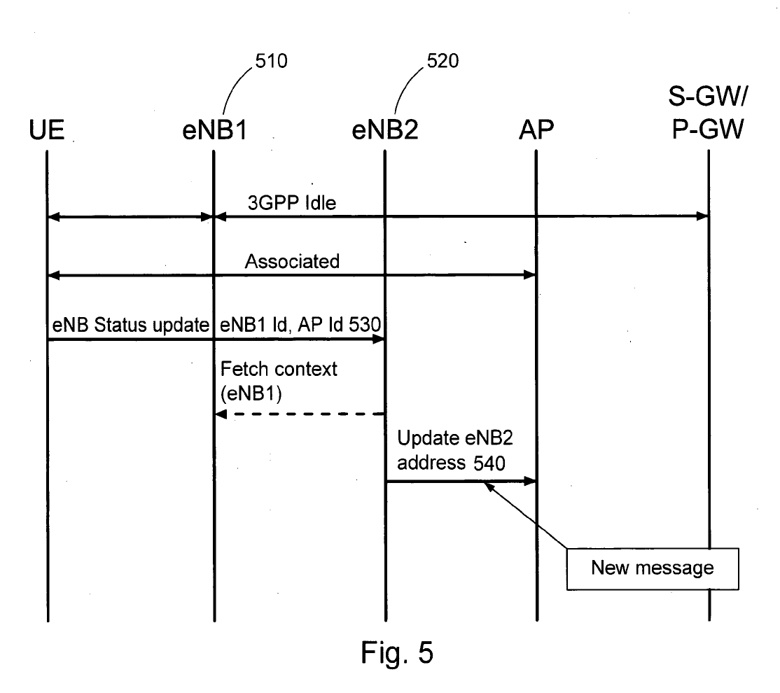

FIG. 5 illustrates changing an eNB in idle mode in accordance with one embodiment. If there is an eNB change in idle mode (where the new eNB 520 may be in a same tracking area as the old eNB 510), the UE may supply one or more of an eNB ID of the previous eNB 510, an Access Point (AP) ID, and the DRX configuration to the target eNB 520 in an eNB status update message 530. The previous eNB may correspond the eNB on which the UE was last camping on.

As an optional feature, the target eNB may use the previous (source) eNB's ID to fetch the UE's context information. The target eNB may also communicate a change in eNB address information in message 540 and establish ANR mapping. The target eNB may communicate the change to the AP using the received AP ID in the update message 530. The communication may occur over the RAN-WLAN interface.

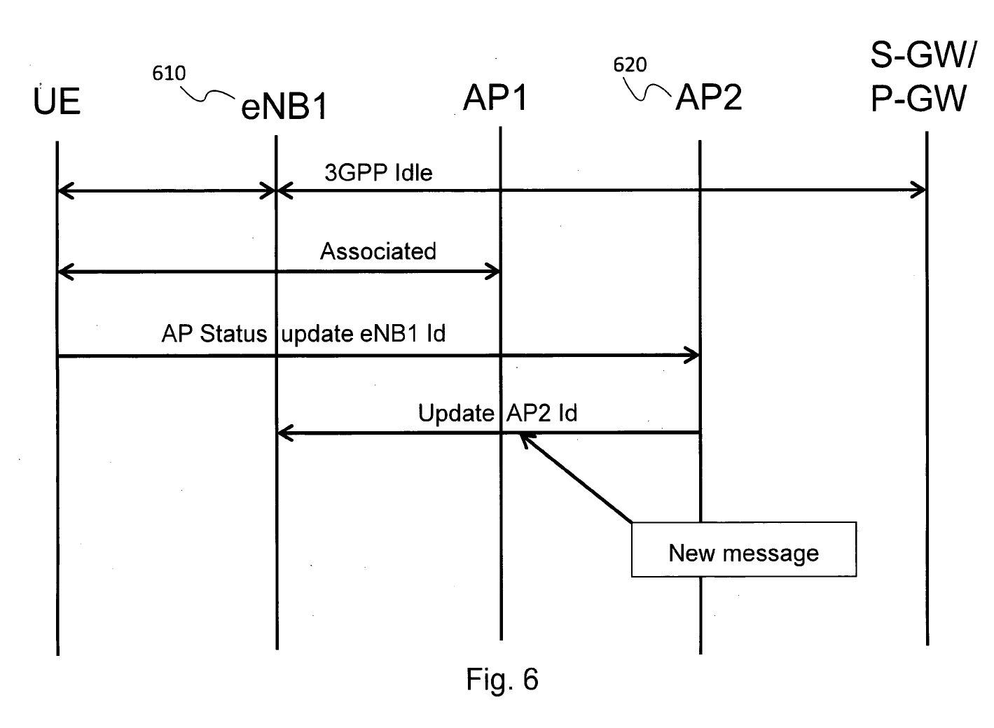

FIG. 6 illustrates an Access-Point change in idle mode in accordance with one embodiment. If there is an Access Point change while the UE is in idle mode, the UE may inform the target AP 620 of the associated eNB information (the associated eNB being eNB 1 610). The target AP 620 may communicate its AP ID over the RAN-WLAN interface to the eNB 610. This communication may help retain the RAN-WLAN address mapping, even in idle mode. Embodiments of the present invention may allow establishment of ANR, when the UE is registered to 3GPP in idle mode. The process of FIG. 6 may be independently implemented.

In connected mode, if there is a change in eNB or Access Point due to UE mobility, the new eNB address information or the new Access Point address information could be communicated to the corresponding entity over the RAN-WLAN interface. Such communication could make use of the same signalling messages used for idle mode as shown in FIGS. 5 and 6.

In certain embodiments of the present invention, if a WLAN-RAN interface is present, the UE may only have to inform the 3GPP RAN node about (1) the ID of the WLAN AP that the UE is using, and (2) the UE's unique identifier. The RAN node may then retrieve, for example, the International-Mobile-Subscriber-Identity (IMSI) from the Mobility-Management-Entity (MME) (as the MME stores the Globally-Unique-Temporary-ID-IMSI (GUTI-IMSI) mapping), and the RAN node may contact the AP for further information on this specific UE. This information may be used for onload decisions.

Embodiments of the present invention may comprise a mechanism where a UE (that is registered in idle mode with 3GPP) with ongoing traffic in WLAN may promptly announce its presence when camping on a new RAN node. This announcement may make the UE “visible” to the RAN node. In turn, the RAN node may then consider this idle UE as a potential onload candidate, thus increasing the cell load. The RAN node may even decide to onload this UE's traffic based on policy rules and/or a subscriber class, for example. The RAN node is able to perform the onloading if the RAN node knows that such UEs are connected to the WLAN network and that these UEs are within the RAN node's coverage area.

UEs that are idle in 3GPP may promptly announce their presence to the RAN node, where the UEs are camping. The UEs may announce their presence using an unprotected Signaling-Radio-Bearer 0 (SRB0) message such as, for example, an RRCConnectionReestablishment message.

There may be different levels of detail with which the UEs can announce themselves to the RAN node. At the lowest level, the eNB may only know that a certain number of UEs are WLAN active. At the next level, the eNB may know which UEs are there, and/or how much WLAN traffic the UEs are carrying, for example.

In one embodiment, the eNB may be informed about the presence of the UE with WLAN traffic, but no information about the UE is generally relayed. The information may potentially be transmitted in the RACH. One possible advantage of using this embodiment is simplicity.

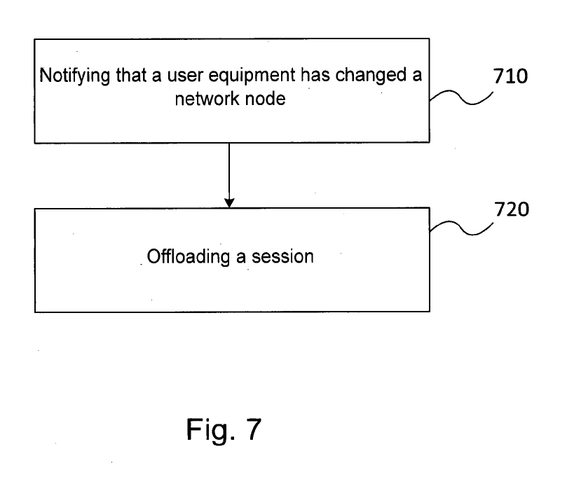

FIG. 7 illustrates a logic flow diagram of a method according to certain embodiments of the invention. The method illustrated in FIG. 7 may comprise, at 710, notifying, by a user equipment, that the user equipment has changed a network node upon which the user equipment is camped on. The user equipment may change from camping on a first network node to camping on a second network node. The user equipment may be in idle mode while camping on the first and the second network node. The first network node and the second network node may both belong to a first network. The notifying may be performed when the user equipment maintains a session to a third network node of a second network. The notifying may be not performed when the user equipment is not maintaining a session to the third network node of the second network. The method may also comprise, at 720, offloading a session.

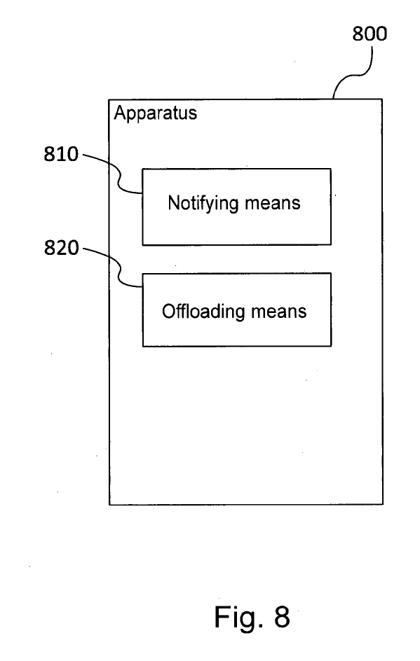

FIG. 8 illustrates an apparatus in accordance with one embodiment. Apparatus 800 may comprise a notifying means 810 to notify that the apparatus 800 has changed a network node upon which the apparatus 800 is camped on. The apparatus 800 may change from camping on a first network node to camping on a second network node. The apparatus 800 may be in idle mode while camping on the first and the second network node. The first network node and the second network node may both belong to a first network. The notifying may be performed when apparatus 800 maintains a session to a third network node of a second network. The notifying may be not performed when apparatus 800 is not maintaining a session to the third network node of the second network. Apparatus 800 may also comprise offloading means 820 to offload a session.

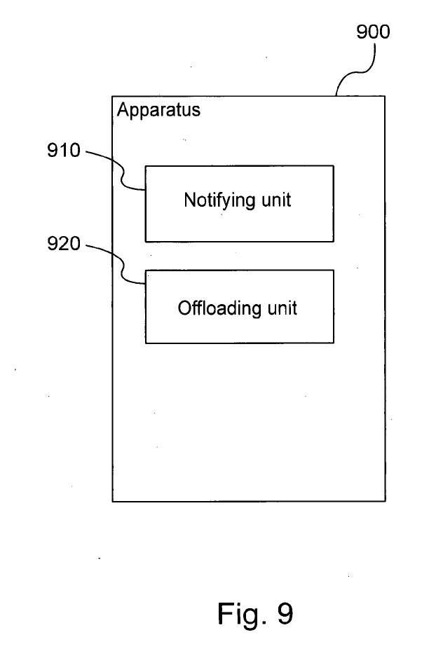

FIG. 9 illustrates an apparatus in accordance with one embodiment. Apparatus 900 may comprise an notifying unit 910 to notify that the apparatus 900 has changed a network node upon which the apparatus 900 is camped on. The apparatus 900 may change from camping on a first network node to camping on a second network node. Apparatus 900 may be in idle mode while camping on the first and the second network node. The first network node and the second network node may both belong to a first network. The notifying may be performed when apparatus 900 maintains a session to a third network node of a second network. The notifying may be not performed when apparatus 900 is not maintaining a session to the third network node of the second network. Apparatus 900 may also comprise offloading unit 920 to offload a session.

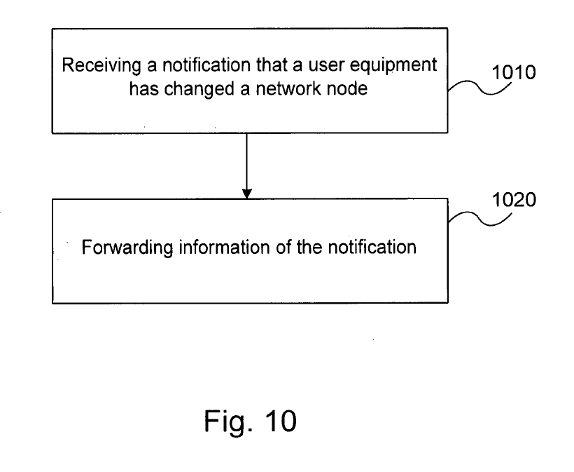

FIG. 10 illustrates a method in accordance with one embodiment. The method may comprise, at 1010, receiving, by a first network node, a notification that a user equipment has changed a network node upon which the user equipment is camped on. The user equipment may change from camping on a second network node to camping on the first network node. The user equipment may be in idle mode while camping on the first and the second network node. The second network node and the first network node may both belong to a first network. The method may comprise, at 1020, forwarding information of the notification to a third network node of a second network.

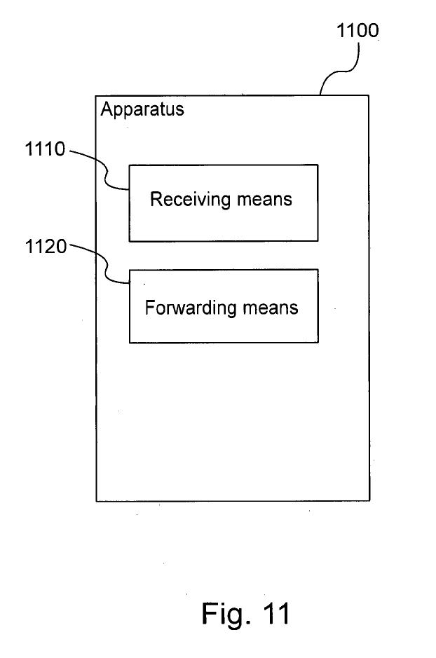

FIG. 11 illustrates an apparatus in accordance with one embodiment. Apparatus 1100 may comprise receiving means 1110 to receive a notification that a user equipment has changed a network node upon which the user equipment is camped on. The user equipment may change from camping on a first network node to camping on apparatus 1100. The user equipment may be in idle mode while camping on the apparatus and the first network node, and the first network node and the apparatus may both belong to a first network. Apparatus 1100 may comprise forwarding means 1120 to forward information of the notification to a second network node of a second network.

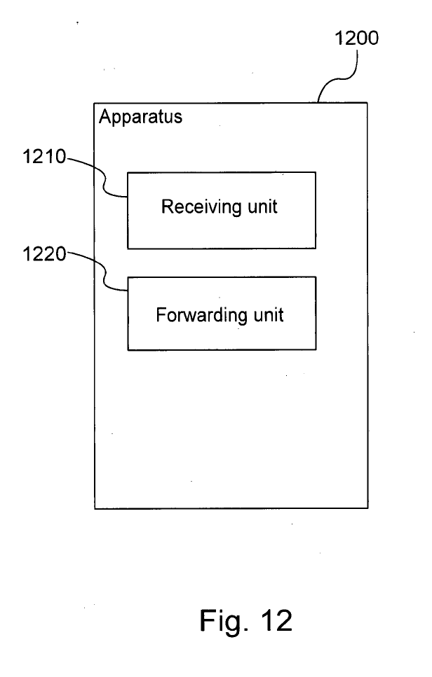

FIG. 12 illustrates an apparatus in accordance with one embodiment. Apparatus 1200 may comprise receiving unit 1210 to receive a notification that a user equipment has changed a network node upon which the user equipment is camped on. The user equipment may change from camping on a first network node to camping on apparatus 1200. The user equipment may be in idle mode while camping on the apparatus 1200 and the first network node, and the first network node and the apparatus may both belong to a first network. Apparatus 1200 may comprise forwarding unit 1220 to forward information of the notification to a second network node of a second network.

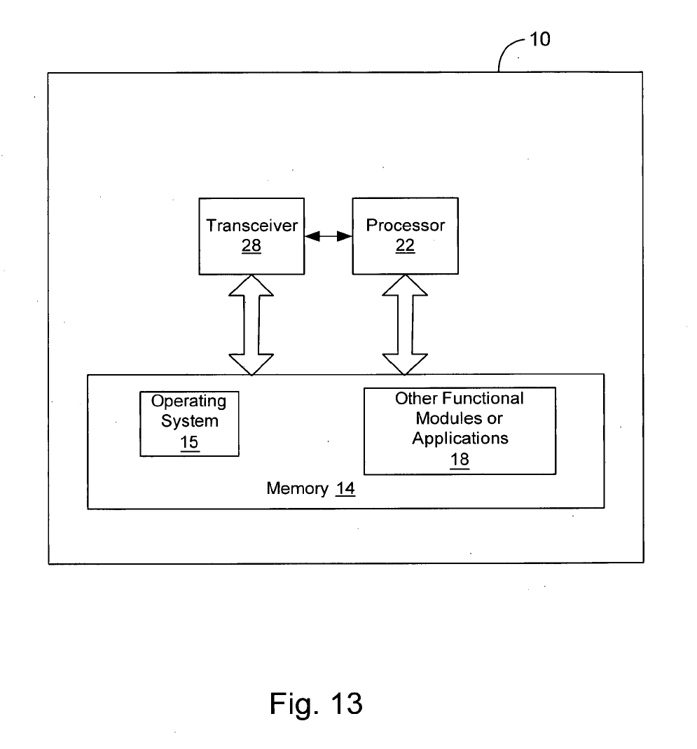

FIG. 13 illustrates an apparatus 10 according to embodiments of the invention. Apparatus 10 can be a device, such as a user equipment, for example. In other embodiments, apparatus 10 can be a base station (for example, a Node B or an evolved Node B) and/or access point, for example.

Apparatus 10 can comprise a processor 22 for processing information and executing instructions or operations. Processor 22 can be any type of general or specific purpose processor. While a single processor 22 is shown in FIG. 13, multiple processors can be utilized according to other embodiments. Processor 22 can also comprise one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further comprise a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 can comprise program instructions or computer program code that, when executed by processor 22, enable the apparatus 10 to perform tasks as described herein.

Apparatus 10 can also comprise one or more antennas (not shown) for transmitting and receiving signals and/or data to and from apparatus 10. Apparatus 10 can further comprise a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 comprising, without limitation, precoding of antenna gain/phase parameters, encoding and decoding of individual bits forming a communication message, formatting of information, and overall control of the apparatus 10, comprising processes related to management of communication resources.

In certain embodiments, memory 14 stores software modules that provide functionality when executed by processor 22. The modules can comprise an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

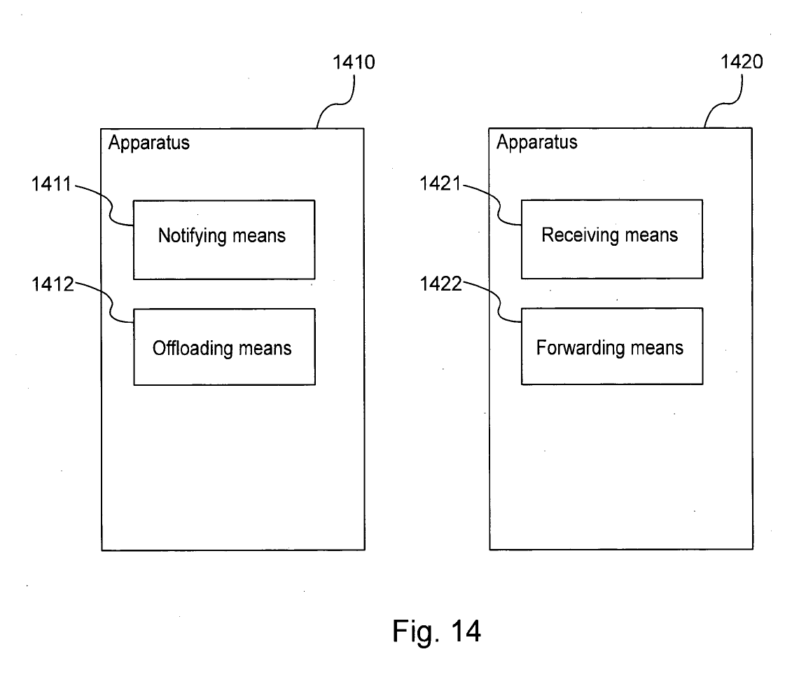

FIG. 14 illustrates a system in accordance with embodiments of the invention. System 1400 may comprise a first apparatus 1410. First apparatus 1410 may comprise notifying means 1411 to notify that the first apparatus 1410 has changed a network node upon which the first apparatus 1410 is camped on. The first apparatus 1410 may change from camping on a first network node to camping on a second apparatus 1420. The first apparatus 1410 may be in idle mode while camping on the first network node and the second apparatus 1420. The first network node and the second apparatus 1420 both belong to a first network. The notifying may be performed when the first apparatus 1410 maintains a session to a second network node of a second network. The notifying may be not performed when first apparatus 1410 is not maintaining a session to the second network node of the second network. The first apparatus 1410 may also comprise offloading means 1412 to offload a session. The system 1400 may comprise a second apparatus 1420. The second apparatus 1420 may comprise receiving means 1421 to receive the notification that the first apparatus 1410 has changed a network node upon which the first apparatus 1410 is camped on. The second apparatus 1420 may comprise forwarding means 1422 to forward information of the notification to the second network node of the second network.

In the above mentioned examples for LTE, an eNB may take the role of an access point or a base station in the RAN network, and, for 3G, a Node B (NB) may take the role of an access point or base station in the RAN network. In the 3G case, the Radio Resource Control (RRC) plane may be implemented in a 3G Radio Network Controller element (RNC) and not in the NB. In an IDLE or CELL_PCH state, the UE may notify the NB about its presence when having WLAN association or traffic. The NB may then inform the RNC. In one embodiment, the IDLE UE may establish, for a short time, an RRC connection to inform the RNC directly via the NB. If the UE is in CELL_FACH state, it may inform the NB about its presence. In this case, the UE may also inform about its WLAN association or traffic. For 5G, an AP may take the role of an access point or a base station in the RAN network, and analog procedures as for the eNB or NB may apply.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1.-33. (canceled)

34. A method, comprising:
notifying, by a user equipment, at least in part in dependence of whether the apparatus maintains a session to a third network node of a second network, that the user equipment has changed a network node upon which the user equipment is camped on, wherein the user equipment changes from camping on a first network node to camping on a second network node, the user equipment is in idle mode while camping on the first and the second network node, and the first network node and the second network node both belong to a first network.

35. The method of claim 34,
wherein the notifying is performed when the user equipment maintains a session to a third network node of a second network; and
wherein the notifying is not performed when the user equipment is not maintaining a session to the third network node of the second network.

36. The method of claim 34, wherein the first and the second network node belong to at least one of a same tracking area and a same routing area.

37. The method of claim 34, wherein the notifying comprises transmitting, to the second network node, at least one of:
an identifier of the third network node, a discontinuous-reception information, an identifier for the user equipment and a second network traffic characteristic;
wherein the identifier for the user equipment comprises at least one of an International Mobile Subscriber Identity, a Globally-Unique-Temporary-Identity, a Temporary-Mobile-Subscriber Identity and a self-generated random number acting as a temporary identity for the user equipment; and
wherein the second network traffic characteristic corresponding to at least one of a second network offloaded traffic volume over a past period, an application traffic type, and an access class.

38. The method of claim 34, wherein the notifying is performed if a broadcast is received which contains an indication that allows the user equipment to do so.

39. An apparatus, comprising
at least one processor; and
at least one memory including computer program code,
wherein the at least one memory and the computer program code are configured, with the at least one processor, to cause the apparatus at least to:
notify, at least in part in dependence of whether the apparatus maintains a session to a third network node of a second network, that the apparatus has changed a network node upon which the apparatus is camped on, wherein the apparatus changes from camping on a first network node to camping on a second network node, the apparatus is in idle mode while camping on the first and the second network node, and the first network node and the second network node both belong to a first network.

40. The apparatus of claim 39,
wherein the notifying is performed when the user equipment maintains a session to a third network node of a second network; and
wherein the notifying is not performed when the user equipment is not maintaining a session to the third network node of the second network.

41. The apparatus of claim 39, wherein the first and the second network node belong to at least one of a same tracking area and a same routing area.

42. The apparatus of claim 39, wherein the apparatus caused to notify comprises the apparatus caused to transmit, to the second network node, at least one of:
an identifier of the third network node, a discontinuous-reception information, an identifier for the apparatus and a second network traffic characteristic,
wherein the identifier for the apparatus comprises at least one of an International Mobile Subscriber Identity, a Globally-Unique-Temporary-Identity, a Temporary-Mobile-Subscriber Identity, and a self-generated random number acting as a temporary identity for the apparatus; and
wherein the second network traffic characteristic corresponding to at least one of a second network offloaded traffic volume over a past period, an application traffic type, and an access class

43. The apparatus of claim 39, wherein the notifying is performed if a broadcast is received which contains an indication that allows the apparatus to do so.

44. The apparatus of claim 39, wherein the apparatus is a user equipment.

45. An apparatus, comprising:
at least one processor; and
at least one memory including computer program code,
wherein the at least one memory and the computer program code are configured, with the at least one processor, to cause the apparatus at least to:
receive a notification that a user equipment has changed a network node upon which the user equipment is camped on, wherein the user equipment changes from camping on a first network node to camping on the apparatus, the user equipment is in idle mode while camping on the apparatus and the first network node, and the first network node and the apparatus both belong to a first network; and
forward information of the notification to a second network node of a second network.

46. The apparatus of claim 45, wherein the notification is not related to a tracking area update notification or a routing area update notification.

47. The apparatus of claim 45, the at least one memory and the computer program code are configured, with the at least one processor, to further cause the apparatus at least to:
fetch user-equipment context information from the first network node.

48. The apparatus of claim 45, wherein the notification comprises at least one of:
an identifier of the second network node,
a discontinuous reception information,
an identifier for the user equipment, and
a second network traffic characteristic;
wherein the identifier for the user equipment comprises at least one of an International Mobile Subscriber Identity, a Globally-Unique-Temporary-Identity, a Temporary-Mobile-Subscriber Identity and a self-generated random number acting as a temporary identity for the user equipment, and
wherein the second network traffic characteristic corresponding to at least one of a second network offloaded traffic volume over a past period, an application traffic type, and an access class.

49. The apparatus of claim 45, the at least one memory and the computer program code are configured, with the at least one processor, to further cause the apparatus at least to:
transmit an indication to a node of the first network; and
enable the sending of the notification by the node of the first network.

50. The apparatus of claim 45, wherein the information comprises at least one of an identifier of the apparatus and a discontinuous reception information.

51. The apparatus of claim 45, wherein the apparatus is a base station.
